(19) United States
(12) Patent Application Publication
(10) Pub. No.: US 2025/0121361 A1
(43) Pub. Date: Apr. 17, 2025

(54) METHOD FOR REGENERATION OF SPENT CATALYST AFTER CATALYTIC CRACKING OF LIGHT HYDROCARBONS

(71) Applicant: CHEVRON U.S.A. INC., San Ramon, CA (US)

(72) Inventors: Xiaoying OUYANG, Albany, CA (US); Alexander E. KUPERMAN, Midland, MI (US); Huping LUO, Moraga, CA (US); Rahul S. BHADURI, Moraga, CA (US); Christopher LANE, Kensington, CA (US)

(21) Appl. No.: 18/915,198

(22) Filed: Oct. 14, 2024

Related U.S. Application Data
(60) Provisional application No. 63/590,299, filed on Oct. 13, 2023.

(51) Int. Cl. B01J 23/94; B01J 23/755; C01B 3/30

(52) U.S. Cl. CPC B01J 23/94; B01J 23/755; C01B 3/30; C01B 2203/0277; C01B 2203/1058; C01B 2203/1241; C01B 2203/148

(57) ABSTRACT

Methods for regenerating spent catalysts, including spent catalysts used in in the catalytic conversion of a hydrocarbon feedstock. The method and associated processes comprising the method are useful to recover spent catalysts used in the petroleum and chemical processing industries. The method generally involves the use of an aqueous leaching solution to leach catalytically active metals from the spent catalyst so that solid carbon built up on the catalyst may be separated from the catalyst metals. The recovered catalyst metals, or a catalyst formed therefrom, may then be re-used in a catalytic conversion process.

### CROSS REFERENCE TO RELATED APPLICATIONS

This application is related to the following application, and claims the benefit of priority thereto, as a continuation of U.S. Provisional Patent Appl. Ser. No. 63/590,299, filed on 13 Oct. 2023, entitled “METHODS FOR REGENERATION OF SPENT CATALYST AFTER CATALYTIC CRACKING OF LIGHT HYDROCARBONS”, the disclosure of which is herein incorporated in its entirety.

### FIELD OF THE INVENTION

The disclosure concerns methods for regenerating catalysts including recovering carbon and metals from spent catalysts, such as spent cracking catalysts that may be used to produce hydrogen.

### BACKGROUND OF THE INVENTION

With the increasing interest in and need for clean fuels, energy producers have sought out new methods to produce hydrogen and other clean fuel products. Hydrogen production via a direct, nonoxidative conversion of light hydrocarbons, such as methane, ethane, and natural gas, is desirable since it potentially requires a lower energy input and a lower carbon intensity than commercially available technology. Steam methane reforming technology, for example, with or without carbon capture and sequestration, is significantly more energy intensive compared with methane catalytic cracking. Catalytic cracking of natural gas light hydrocarbons has the potential to produce hydrogen product using available gas and distribution assets to supply hydrogen at reduced production and transport costs.

Catalytic cracking of light hydrocarbons remains at an early development stage. In the case of methane pyrolysis catalyzed by Fe and/or Ni-based catalysts, for example, a cost-effective solution is needed for the regeneration of spent catalyst. Although Fe and Ni-based catalysts are typically active in the 550-800° C. temperature range, they deactivate over time as active sites on the catalyst metal particles are blocked by carbon deposits. Use of a once-though, throw-away catalyst without regeneration, however, is undesirable due to high commercial scale costs. Physical and/or chemical separation of carbon from the spent catalyst may therefore be necessary to provide an economical process. While such a separation scheme is currently unavailable at a commercial scale, it would be highly desirable to be able to economically regenerate spent catalyst for use in the catalytic cracking of light hydrocarbons.

### SUMMARY OF THE INVENTION

The present disclosure is, in part, directed to a method for regenerating catalyst from spent catalysts, in particular from catalyst that is deactivated during the catalytic cracking of light hydrocarbons due to the buildup of carbon deposits. One of the goals is to provide methods for spent catalyst regeneration processes that provide lower capital and operating costs for catalyst regeneration, as well as for associated uses of the regenerated catalyst. The invention provides an innovative approach for catalyst regeneration that addresses important clean fuels and environmental sustainability needs in the oil and gas industries, especially in the production of hydrogen from light hydrocarbons.

Methods for regenerating spent catalysts are disclosed. The methods and associated processes comprising the method are useful to recover catalysts used in the petroleum and chemical processing industries, particularly in the catalytic cracking of light hydrocarbons. The methods generally involve contacting spent catalyst having solid carbon formed on the surface of the catalyst to a separation process in which the catalyst is combined with an aqueous leaching solution and subjected to a leaching process to leach the catalytically active metals from the catalyst. The leached aqueous metal salt solution formed contains the solid carbon, which is then subjected to a solid-liquid separation to recover the solid carbon and the leached metal salt solution. The recovered metal salt solution, a metal derived therefrom, or a catalyst formed from the metal salt solution, may then be recovered as a product or returned to a cracking process. For example, in the case of a fluidized bed reactor process for the catalytic conversion of a light hydrocarbon feedstock, the recovered product, i.e., the metal salt solution, a metal derived therefrom, or a catalyst formed from the metal salt solution, may be returned or transferred to the cracking reactor.

### BRIEF DESCRIPTION OF THE DRAWINGS

The scope of the disclosure is not limited by any representative figures accompanying this disclosure and is to be understood to be defined by the claims of the application.

FIG. 1 is a general block diagram schematic illustration of an embodiment of a method for the direct injection of leached metal solution comprising cracking catalyst into a fluidized bed reactor (FBR) according to the disclosure.

FIG. 2 is a general block diagram schematic illustration of an embodiment of a method for the regeneration of cracking catalyst and return of regenerated solid cracking catalyst into a fluidized bed reactor (FBR) according to the disclosure.

### DETAILED DESCRIPTION

Although illustrative embodiments of one or more aspects are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“Supported catalyst” generally refers to catalyst compositions having a “support” material, including conventional catalyst forms containing a preformed, shaped catalyst support which is then loaded with metals via impregnation or deposition to form the supported catalyst. The term “support”, particularly as used in the term “supported catalyst” and “catalyst support”, refers to conventional materials that are typically a solid with a high surface area, to which catalyst materials are affixed. Support materials may be inert or participate in the catalytic reactions and may be porous or non-porous. Typical catalyst supports include various kinds of carbon, such as activated carbon, carbon nanotubes, and graphene, alumina, silica, and silica-alumina, e.g., amorphous silica aluminates, zeolites, alumina-boria, silica-alumina-magnesia, silica-alumina-titania, metal oxides such as TiO₂, MgO, and CeO₂, to name a few, and materials obtained by adding other zeolites and other complex oxides thereto.

“Slurry catalyst” may be used interchangeably with “bulk catalyst” or “unsupported catalyst” or “self-supported catalyst,” meaning that the catalyst composition is not of the conventional catalyst form with a preformed, shaped catalyst support which is then loaded with metals via impregnation or deposition catalyst. Such bulk catalyst may be formed through precipitation or may have a binder incorporated into the catalyst composition. Slurry or bulk catalyst may also be formed from metal compounds and without any binder. In slurry form, such catalyst comprises dispersed particles in a liquid mixture such as hydrocarbon oil, i.e., a “slurry catalyst”.

The term “Hydrogen” or “hydrogen” refers to hydrogen itself, and/or a composition comprising hydrogen.

“Hydrocarbonaceous”, “hydrocarbon” and similar terms refer to a compound containing only carbon and hydrogen atoms. Other identifiers may be used to indicate the presence of particular groups, if any, in the hydrocarbon.

“Spent catalyst” refers to a catalyst that has been used in a catalytic processing operation and whose activity has thereby been diminished. In general, a catalyst may be termed “spent” if a reaction rate constant of the catalyst is below a certain specified value relative to a fresh catalyst at a specified temperature. In some circumstances, a catalyst may be “spent” if the reaction rate constant, relative to fresh unused catalyst, is 80% or less, or perhaps 50% or less in another embodiment. In one embodiment, the metal components of the spent catalyst comprise at least one of catalytic cracking metal, such as Fe, Ni, Co, Cu, Zn, Mn, Mo, W, Pd, Pt, La, Ce, or a combination thereof, preferably Fe and/or Ni, optionally with a promoter, such as Mg, Ca, Ba, K, or a combination thereof.

“Metal” refers to metals in their elemental, compound, or ionic form. “Metal precursor” refers to the metal compound feed in a method or to a process. The term “metal”, “metal precursor”, or “metal compound” in the singular form is not limited to a single metal, metal precursor, or metal compound, e.g., a Group VIB, Group VIII, or Group V metal, but also includes the plural references for mixtures of metals. The terms “soluble” and “insoluble” in reference to a metal or metal compound means the metal component is in a protic liquid form unless otherwise stated, or that the metal or metal compound is soluble or insoluble in a specified step or solvent.

“Group IIA” or “Group IIA metal” or “Group 2” refers, e.g., to beryllium (Be), magnesium (Mg), calcium (Ca), barium (Ba), and combinations thereof in any elemental, compound, or ionic form.

“Group IIIB” or “Group IIIB metal” or “Group 3” refers, e.g., to lanthanum (La) in any elemental, compound, or ionic form.

“Group VB” or “Group VB metal” or “Group 5” refers, e.g., to vanadium (V) in any elemental, compound, or ionic form.

“Group VIB” or “Group VIB metal” or “Group 6” refers, e.g., to chromium (Cr), molybdenum (Mo), tungsten (W), and combinations thereof in any elemental, compound, or ionic form.

“Group VIIB” or “Group VIIB metal” or “Group 7” refers, e.g., to manganese (Mn), molybdenum (Mo), tungsten (W), and combinations thereof in any elemental, compound, or ionic form.

“Group VIIIB” or “Group VIIIB metal” or “Groups 8-10” refers, e.g., to iron (Fe), cobalt (Co), nickel (Ni), ruthenium (Ru), rhenium (Rh), rhodium (Rh), palladium (Pd), osmium (Os), iridium (Ir), platinum (Pt), and combinations thereof in any of elemental, compound, or ionic form.

“Group IB” or “Group IB metal” or “Group 11” refers, e.g., to copper (Cu), silver (Ag), gold (Au), and combinations thereof in any elemental, compound, or ionic form.

“Group IIB” or “Group IIB metal” or “Group 12” refers, e.g., to zinc (Zn), cadmium (Cd), mercury (Hg), and combinations thereof in any elemental, compound, or ionic form.

The reference to Ni or “nickel” or Fe or “iron” is by way of exemplification only and is not meant to exclude other metal components and mixtures thereof that can be used in catalytic cracking catalysts. Similarly, the reference to other metals is by way of exemplification only for any metal component that may be present in spent catalysts and is not intended to exclude other metals/compounds and mixtures that may be present in the spent catalyst to be regenerated.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. Zeolites, crystalline aluminophosphates and crystalline silicoaluminophosphates are representative examples of molecular sieves.

In this disclosure, while compositions and methods or processes are often described in terms of “comprising” various components or steps, the compositions and methods may also “consist essentially of” or “consist of” the various components or steps, unless stated otherwise. Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect.

The terms “a,” “an,” and “the” are intended to include plural alternatives, e.g., at least one. For instance, the reference to “a catalyst” or “a metal” includes, but is not limited to, combinations of two or more such catalysts or metals, and the like.

All numerical values within the detailed description and the claims herein are modified by “about” or “approximately” the indicated value, and consider experimental error and variations that would be expected by a person having ordinary skill in the art. As used herein, the terms “about,” “approximate,” “at or about,” and “substantially” mean that the amount or value in question can be the exact value or a value that provides equivalent results or effects as recited in the claims or described herein. That is, it is understood that amounts, sizes, formulations, parameters, and other quantities and characteristics are not and need not be exact but may be approximate and/or larger or smaller, as desired, reflecting tolerances, conversion factors, rounding off, measurement error, and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated +10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Other methods, processes, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

In one aspect, the present disclosure concerns methods for regenerating spent catalyst, wherein the spent catalyst is used in a process for the catalytic conversion of a hydrocarbon feedstock. For example, the process may comprise contacting a hydrocarbon feedstock with a catalytic cracking catalyst in a cracking reactor under catalytic cracking process conditions to produce a hydrogen product stream, wherein the catalyst comprises one or more catalytically active metals, and wherein solid carbon forms on the surface of the catalyst during the cracking process; transferring a portion of the catalyst from the cracking reactor to a separation zone wherein the catalyst is combined with an aqueous leaching solution and subjected to a leaching process to leach the catalytically active metals from the catalyst, thereby forming a leached aqueous metal salt solution containing solid carbon; subjecting the aqueous metal salt solution containing solid carbon to solid-liquid separation to recover the solid carbon and the leached metal salt solution; and transferring the recovered metal salt solution, a metal derived therefrom, or a catalyst formed from the metal salt solution, to the cracking reactor.

The method provides for an improved recovery and regeneration of spent catalyst and a cost-effective simplified approach to the recovery of spent catalyst metals and carbon deposited on the catalyst. The method utilizes a leaching extraction stage, i.e., an aqueous leach extraction of spent catalyst metal(s) to form a leached aqueous metal salt solution containing solid carbon. The method may utilize one or more leaching extraction stages comprising an aqueous leach extraction of the catalyst metals. The method does not require the use of additional extraction stages (within the method), such as the addition of other solvents (e.g., tertiary amines for extraction of soluble metals) or additional treatment of organic compounds (e.g., with activated carbon, bentonite).

In general, the cracking catalyst may be any catalyst that is suitable to crack light hydrocarbons. Both supported and unsupported catalysts may be used, e.g., according to those catalysts known and described in the art and in patent publications. Supported cracking catalysts may generally comprise a refractory inorganic oxide support and a Group 6 metal modifier and/or a Group 8-10 metal. In some embodiments, the catalyst comprises a refractory inorganic oxide support, a Group 6 metal and a Group 8-10 metal. The oxide support may also be referred to herein as a binder. The support of the cracking catalyst may be prepared from or comprise carbon, such as activated carbon, carbon nanotubes, and graphene, alumina, silica, silica/alumina, e.g., amorphous silica aluminates, zeolites, alumina-boria, silica-alumina-magnesia, silica-alumina-titania, titania, magnesia, zirconia, and the like, metal oxides such as TiO₂, MgO, and CeO₂, to name a few, materials obtained by adding other zeolites and other complex oxides thereto, or combinations thereof. Zeolites may be used as the support, alone or in combination with another support material. The catalyst support may comprise amorphous materials, crystalline materials, or combinations thereof. Examples of amorphous materials include, but are not limited to, amorphous alumina, amorphous silica, amorphous silica-alumina, and the like.

In some embodiments, the support may comprise amorphous alumina. When using a combination of silica and alumina, the distribution of silica and alumina in the support may be either homogeneous or heterogeneous. The support may contain an alumina gel in which is dispersed silica, silica/alumina, or alumina base material. The support may also contain refractory materials other than alumina or silica, such as for example other inorganic oxides or clay particles, provided that such materials do not adversely affect the cracking activity of the catalyst.

In some embodiments, silica and/or alumina comprise at least about 90 wt. % of the support of the cracking catalyst, and in some embodiments the support may be at least substantially all silica or all alumina.

The metal of the catalyst may generally comprise a metal selected from Groups 8-10 of the Periodic Table, optionally in combination with other metals, including metals from Groups 1, 2, 5-7, 11, and 12. Typical cracking catalyst metals are selected from Fe, Ni, Co, Cu, Zn, Mn, Mo, W, Pd, Pt, La, Ce, or a combination thereof, preferably Fe and/or Ni, optionally with a promoter, such as Mg, Ca, Ba, K, or a combination thereof. In some embodiments, the Group 8-10 metal of the cracking catalyst comprises a Group 9 metal, a Group 10 metal, or combinations thereof. In some embodiments, the Group 8-10 metal of the catalyst comprises or is Fe, Ni, and/or Co. In some embodiments, the Group 8-10 metal of the catalyst comprises or is Fe and/or Ni. In some embodiments, the Group 8-10 metal of the catalyst comprises Co and Ni. In some embodiments, the Group 8-10 metal is an oxide, hydroxide or salt. In some embodiments, the Group 8-10 metal is a salt. The amount of the Group 8-10 metal in the catalyst is generally from 0.1 to 20 wt. % (for example, from 1.0, or 2.0 to 10 wt. %), based on the bulk dry weight of the catalyst, calculated as the metal oxide. In some embodiments, the Group 6 metal of the catalyst is selected from Cr, Mo, W, and combinations thereof. In some embodiments, the Group 6 metal of the catalyst comprises or is Mo and/or W. In some embodiments, the Group 6 metal is an oxide, an oxo acid, or an ammonium salt of an oxo or polyoxoanion. When present, the amount of the Group 6 metal employed in the catalyst may generally be from 5 to 50 wt. % (for example, from 10 to 40 wt. %, or from 15 to 30 wt. %), based on the bulk dry weight of the catalyst, calculated as the metal oxide.

In some embodiments, the catalyst metal(s) may be dispersed on the inorganic oxide support. A number of methods are known in the art to deposit catalyst metal(s), or compounds comprising such metals, onto supports; such methods include ion exchange, impregnation, co-precipitation, and electro-winning techniques. In some embodiments, the impregnation of the support with catalyst metal(s) may be performed at a controlled pH value. The catalyst metal(s) may be added to the impregnating solution as a metal salt, such as a halide salt, and/or an amine complex, and/or a salt of a mineral acid. Other examples of metal salts that may be used include nitrates, carbonates, and bicarbonates, as well as carboxylic acid salts such as acetates, citrates, and formates.

The impregnated support may be allowed to stand with the impregnating solution, e.g., for a period in the range from about 2 to about 24 hours. Following impregnation of the oxide support with the catalyst metal(s), the impregnated support can be dried and/or calcined. After the catalyst has been dried and calcined, the prepared catalyst may be reduced with hydrogen or sulfided with a sulfur-containing compound, as is conventional in the art, and placed into service.

The hydrocarbon feedstock used in the catalytic cracking process is generally a light hydrocarbon, e.g., a single C₂ to C₆ hydrocarbon feed or a mixture of one or more C₂ to C₆ hydrocarbons. Suitable hydrocarbon feeds include methane, ethane, natural gas, and the like, with natural gas and methane being preferred. Hydrocarbon sources are not particularly limited such that fossil, biomass, and/or biogas sources may be used. In some cases, the hydrocarbon feedstock may comprise methane in an amount of at least about 1 wt. %, or 2 wt. %, or 3 wt. %, or 4 wt. %, or 5 wt. %, or 10 wt. %, or 20 wt. %, or 30 wt. %, or 40 wt. %, or 50 wt. %, or 60 wt. %, or 70 wt. %, or 80 wt. %, or 90 wt. %; or less than about 100 wt. %, or 90 wt. %, or 80 wt. %, or 70 wt. %, or 60 wt. %, or 50 wt. %, or 40 wt. %, or 30 wt. %, or 20 wt. %, or 10 wt. %, or 5 wt. %, or 4 wt. %, or 3 wt. %, or 2 wt. %, or 1 wt. %; or in the range of about 1-100 wt. %, or 2-100 wt. %, or 3-100 wt. %, or 4-100 wt. %, or 5-100 wt. %, or 10-100 wt. %, or 20-100 wt. %, or 30 100 wt. %, or 40-100 wt. %, or 50-100 wt. %, or 60-100 wt. %, or 70-100 wt. %, or 80-100 wt. %, or 90 100 wt. %.

The catalytic conversion process generally makes use of a fluidized bed reactor as the cracking reactor. While the cracking reactor may be contained in a single stage reactor, more than one reactor and fixed bed reactors may also be used. Typical cracking reactor operating conditions include: a temperature in the range of about 550° C. to 800° C., or 550° C. to 750° C., or 600° C. to 800° C., or 600° C. to 750° C., or 650° C. to 800° C., or 650° C. to 750° C., or 675° C. to 800° C., or 675° C. to 750° C., or 675° C. to 725° C., preferably about 700° C.; a pressure in the range of about 0.1 MPa to about 2 MPa, or about 0.1 to about 0.7 MPa; and a feed rate of hydrocarbon feedstock in terms of cracking reactor feedstock residence time in the range from about 0.1 s to about 10 s.

A catalyst regeneration section comprising a separation zone is used in conjunction with the cracking reactor. The separation zone comprises a leaching process wherein the catalyst is contacted with an aqueous leaching solution under leaching process conditions to leach the catalyst metals and separate solid carbon deposited on the catalyst from the catalyst metals. The solid carbon formed on the catalyst may be in a filamentous form, such as a nanotube form comprising single walled or multi walled structures. Mechanical process means may also be used to separate the carbon from the catalyst, including grinding, milling, chopping, or other size reduction means.

The leaching process involves contacting the spent catalyst with an acid or an ammoniacal solution to produce an aqueous metal salt solution. Suitable acids include nitric, sulfuric, hydrochloric, acetic, or a mixture or combination thereof. For example, when the catalyst comprises Fe, the leaching process may comprise contacting the catalyst with a dilute sulfuric acid solution, followed by liquid-solid separation, and carbon recovery. Similarly, when the catalyst comprises Ni, the leaching process may comprise contacting the catalyst with a dilute sulfuric acid solution or dilute ammoniacal solution, followed by liquid-solid separation, and carbon recovery. Leaching process conditions may generally comprise a pH of less than about 4, or 3, or 2, or 1, or in the range of about 0 to 4, or 0 to 3, or 0 to 2, or 0 to 1; and a temperature of less than about 180° C., or 170° C., or 160° C., or 150° C., or 140° C., or 130° C., or 120° C., or 110° C., or 100° C., or 90° C., or 80° C., or 70° C., or 60° C., or 50° C., or 40° C., or 30° C., or in the range of about 20-180° C., or 20-170° C., or 20-160° C., or 20-150° C., or 20-140° C., 20-130° C., or 20-120° C., or 20-110° C., or 20-100° C., 20-90° C., or 20-80° C., or 20-70° C., or 20-60° C., or 20-50° C., or 20-40° C., or 20-30° C. While not limited thereto, typical acid concentrations may be in the range of about 10-70 wt. %.

In one scheme (scheme 1), the aqueous metal salt solution recovered from the liquid-solid separation may be returned to the cracking reactor, preferably directly returned or injected into the reactor such that the metal salts decompose to form active catalyst particles. In an alternate scheme (scheme 2), the aqueous metal salt solution recovered from the liquid-solid separation may be subjected to co-precipitation or electrowinning of the metal salts, followed by drying to form solid catalyst. The solid catalyst is then re-introduced into the cracking reactor.

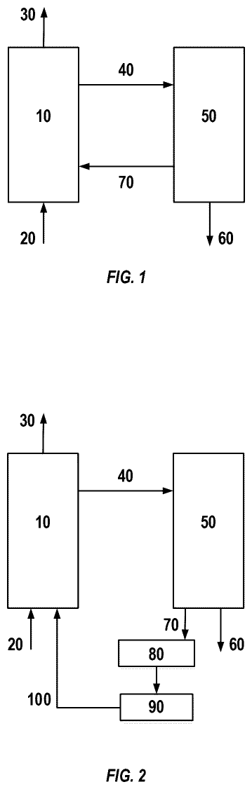

An illustration of a process according to the scheme 1 direct injection embodiment is shown schematically in FIG. 1. Fluidized bed reactor 10 is operated at suitable cracking conditions in which a hydrocarbon feedstream 20 such as methane or natural gas is fed to the reactor. Hydrogen 30 produced during the cracking reaction is withdrawn. Spent catalyst 40 is also withdrawn and sent to the separation zone 50. The spent catalyst is contacted with the leaching solution in a leaching process within the separation zone forming an aqueous metal salt solution containing solid carbon. The solid carbon 60 is separated from the metal salt solution and collected and the metal salt solution 70 is returned to the cracking reactor.

In the alternate scheme 2 embodiment, fluidized bed reactor 10 is operated at suitable cracking conditions in which a hydrocarbon feedstream 20 such as methane or natural gas is fed to the reactor. Hydrogen 30 produced during the cracking reaction is withdrawn. Spent catalyst 40 is also withdrawn and sent to the separation zone 50. The spent catalyst is contacted with the leaching solution in a leaching process within the separation zone forming an aqueous metal salt solution containing solid carbon. The solid carbon 60 is separated from the metal salt solution and collected while the metal salt solution 70 is subjected to co-precipitation 80 and drying 90 to form catalyst particles and then returned 100 to the cracking reactor.

### EXAMPLES

Experimental catalyst preparation, catalytic testing, and catalyst recovery studies were carried out as described in the following examples. The examples are provided for purposes of illustration only and are non-limiting embodiments according to the invention.

### Example 1

A Fe₂O₃/Al₂O₃ catalyst (sample #1) was prepared by impregnating Puralox alumina (Sasol SCCA-150/230) with an iron nitrate solution. First 4.2 liters of alumina was sieved through a 60/140 mesh and then calcined at 500° C. for 4 hours. After measuring its density, 4 liters (3552.93 g) of the calcined alumina were weighed out. An iron nitrate solution was prepared by dissolving 5007.53 g of Fe(NO₃)₂ 9H₂O (98% purity) in 831.27 g of deionized water, with the iron nitrate amount calculated to be 1.3 times that required for an 18 wt % loading of Fe₂O₃. The alumina was added to the solution, stirred thoroughly, and the mixture was left to impregnate overnight at 70° C. After drying at 130° C., the material was calcined at 700° C. for 8 hours, resulting in a uniform distribution of Fe₂O₃ on the alumina, with the final product sieved through the 60/140 mesh again to obtain a consistent particle size.

### Example 2

A NiO/Al₂O₃ catalyst (sample #2) was prepared by impregnating Puralox alumina (Sasol SCCA-30/170) with an iron nitrate solution. First 2.3 liters of alumina was sieved through a 170/325 mesh and then calcined at 500° C. for 4 hours. After measuring its density, 2 liters (1707.56 g) of the calcined alumina were weighed out. An iron nitrate solution was prepared by dissolving 1684.59 g of Ni(NO₃)₂ 6H₂O (99+% purity) in 645.27 g of deionized water, with the iron nitrate amount calculated to be 1.3 times that required for an 20 wt % loading of NiO. The alumina was added to the solution, stirred thoroughly, and the mixture was left to impregnate overnight at 70° C. After drying at 130° C., the material was calcined at 700° C. for 8 hours, resulting in a uniform distribution of NiO on the alumina, with the final product sieved through the 170/325 mesh again to obtain a consistent particle size.

### Example 3

Catalytic test: a fluidized bed quartz reactor was used for a methane catalytic cracking reaction at ambient pressure. The diameter of the reactor was 1″. The reactor was set up in a vertical three-zone heater. As-synthesized catalysts (1.3 g) were loaded on a distributor made from a quartz frit which was in the middle of the reactor so that the fluidized catalyst bed was within the isothermal zone of the heater. N₂ gas was used as an internal standard for product analysis using online GC. Prior to each test, the 1.3 g catalyst samples were reduced in situ at 700° C. under 25 mL/min 5 vol % H₂/Ar overnight. Subsequently, the feed was switched to 52 mL/min 90 vol % CH₄/N₂. The methane conversion was calculated based on the disappearance of methane from the feed.

### Example 4

Results of Catalytic Test: Table 1 shows the activity of the two catalysts described above. Both catalysts reached near-equilibrium conversion and good stability within 5 hours.

TABLE 1

| Sample | Methane conversion (%) | Methane conversion (%) |
|---|---|---|
| No. | after 20 min | after 5 h |
| 1 | 85 | 80 |
| 2 | 88 | 82 |

### Example 5

To leach iron oxide from the spent catalyst (from Sample #1) after a 5 hour run, an HNO₃ solution was prepared by diluting concentrated HNO₃ to a concentration of 2 M with deionized water. The spent catalyst was immersed in the nitric acid solution at a ratio of 100 ml of acid per gram of catalyst. The mixture was sonicated for 30 minutes before being transferred to an autoclave, which was then static set in a 120° C. oven for 72 hours to ensure thorough leaching of iron oxide from the alumina support and carbon product. After leaching, the solution was filtered to separate the solid alumina and carbon, and the filtrate was collected for metal recovery. The solid alumina and carbon were then rinsed with deionized water to remove any residual acid and dried at 120° C. for 12 hours. The resulting solids were subjected to ICP analysis, which confirmed that the residual iron oxide was less than 2%.

Additional details concerning the scope of the invention and disclosure may be determined from the appended claims.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

What is claimed is:

1. A process for the catalytic conversion of a hydrocarbon feedstock, the process comprising
contacting a hydrocarbon feedstock with a catalytic cracking catalyst in a cracking reactor under catalytic cracking process conditions to produce a hydrogen product stream, wherein the catalyst comprises one or more catalytically active metals, and wherein solid carbon forms on the surface of the catalyst during the cracking process;
transferring a portion of the catalyst from the cracking reactor to a separation zone wherein the catalyst is combined with an aqueous leaching solution and subjected to a leaching process to leach the catalytically active metals from the catalyst, thereby forming a leached aqueous metal salt solution containing solid carbon;
subjecting the aqueous metal salt solution containing solid carbon to solid-liquid separation to recover the solid carbon and the leached metal salt solution; and
transferring the recovered metal salt solution, a metal derived therefrom, or a catalyst formed from the metal salt solution, to the cracking reactor.

2. The process of claim 1, wherein the hydrocarbon feedstock comprises methane, ethane, C₂ to C₆ hydrocarbons, natural gas, preferably methane or natural gas, and wherein the hydrocarbon feedstock may be derived from a fossil, biomass, or biogas source, or a combination thereof.

3. The process of claim 1, wherein the hydrocarbon feedstock comprises methane in an amount of at least about 1 wt. %, or 2 wt. %, or 3 wt. %, or 4 wt. %, or 5 wt. %, or 10 wt. %, or 20 wt. %, or 30 wt. %, or 40 wt. %, or 50 wt. %, or 60 wt. %, or 70 wt. %, or 80 wt. %, or 90 wt. %; or less than about 100 wt. %, or 90 wt. %, or 80 wt. %, or 70 wt. %, or 60 wt. %, or 50 wt. %, or 40 wt. %, or 30 wt. %, or 20 wt. %, or 10 wt. %, or 5 wt. %, or 4 wt. %, or 3 wt. %, or 2 wt. %, or 1 wt. %; or in the range of about 1-100 wt. %, or 2-100 wt. %, or 3-100 wt. %, or 4-100 wt. %, or 5-100 wt. %, or 10-100 wt. %, or 20-100 wt. %, or 30-100 wt. %, or 40-100 wt. %, or 50-100 wt. %, or 60-100 wt. %, or 70-100 wt. %, or 80-100 wt. %, or 90-100 wt. %.

4. The process of claim 1, wherein the cracking reactor comprises a fluidized bed reactor.

5. The process of claim 1, wherein the cracking catalyst comprises a supported or unsupported catalyst, or a combination thereof.

6. The process of claim 1, wherein the cracking catalyst comprises a support selected from carbon, such as activated carbon, carbon nanotubes, and graphene, alumina, silica-alumina, amorphous silica aluminates, zeolites, alumina-boria, silica-alumina-magnesia, silica-alumina-titania, titania, magnesia, zirconia, and the like, metal oxides such as TiO₂, MgO, and CeO₂, materials obtained by adding other zeolites and other complex oxides thereto, or a combination thereof.

7. The process of claim 1, wherein the cracking catalyst active metals comprise Fe, Ni, Co, Cu, Zn, Mn, Mo, W, Pd, Pt, La, Ce, or a combination thereof, preferably Fe and/or Ni, optionally with a promoter, such as Mg, Ca, Ba, K, or a combination thereof.

8. The process of claim 1, wherein the catalyst is formed from the recovered metal salt solution, such as by co-precipitation, incipient wetness impregnation, or electro-winning techniques.

9. The process of claim 1, wherein the solid carbon formed on the catalyst comprises a filamentous carbon form, such as a nanotube form comprising single-walled or multi-walled structures.

10. The process of claim 1, wherein separation zone comprises a leaching process, optionally in conjunction with mechanical process means, preferably comprising grinding, milling, chopping, or other size reduction means.

11. The process of claim 1, wherein the leaching process comprises contacting the catalyst with an acid solution selected from nitric, sulfuric, hydrochloric, acetic, or a mixture or combination thereof, followed by liquid-solid separation, and carbon recovery.

12. The process of claim 11, wherein the catalyst comprises Ni and the leaching process comprises contacting the catalyst with a dilute sulfuric acid solution or dilute ammoniacal solution, followed by liquid-solid separation, and carbon recovery.

13. The process of claim 11, wherein the catalyst comprises Fe and the leaching process comprises contacting the catalyst with a dilute sulfuric acid solution, followed by liquid-solid separation, and carbon recovery.

14. The process of claim 11, wherein the leaching process conditions comprise a pH of less than about 4, or 3, or 2, or 1, or in the range of about 0 to 4, or 0 to 3, or 0 to 2, or 0 to 1; a temperature of less than about 180° C., or 170° C., or 160° C., or 150° C., or 140° C., or 130° C., or 120° C., or 110° C., or 100° C., or 90° C., or 80° C., or 70° C., or 60° C., or 50° C., or 40° C., or 30° C., or in the range of about 20-180° C., or 20-170° C., or 20-160° C., or 20-150° C., or 20-140° C., 20-130° C., or 20-120° C., or 20-110° C., or 20-100° C., 20-90° C., or 20-80° C., or 20-70° C., or 20-60° C., or 20-50° C., or 20-40° C., or 20-30° C.

15. The process of claim 1, wherein the recovered metal salt solution is injected into the cracking reactor, or directly injected into the reactor.

16. The process of claim 1, wherein the recovered metal salt solution is subjected to co-precipitation, incipient wetness impregnation, electro-winning, and/or drying to form solid catalyst, before it is returned to the reactor.

17. The process of claim 1, wherein the catalytic conversion process conditions comprise one or more of:
a single stage-single reactor;
a temperature in the range of about 550° C. to 800° C., or 550° C. to 750° C., or 600° C. to 800° C., or 600° C. to 750° C., or 650° C. to 800° C., or 650° C. to 750° C., or 675° C. to 800° C., or 675° C. to 750° C., or 675° C. to 725° C., preferably about 700° C.;
a pressure in the range of about 0.1 MPa to about 2 MPa, or about 0.1 to about 0.7 MPa;
a feed rate of hydrocarbon feedstock has a cracking reactor residence time in the range from about 0.1 s to about 10 s.
